(19) United States
(12) Patent Application Publication
(10) Pub. No.: US 2003/0198387 A1
(43) Pub. Date: Oct. 23, 2003

(54) Method and apparatus for image retrieval

(76) Inventors: Tinku Acharya, Chandler, AZ (US); Bhabatosh Chanda, Kharda (IN); Amit K. Das, Botanic Garden (IN); Sanjoy K. Saha, Calcutta (IN)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/128,601

(22) Filed: Apr. 22, 2002

(51) Int. Cl. G06K 9/48

(52) U.S. Cl. 382/199; 382/262; 382/305

(57) ABSTRACT

Embodiments of a method and/or apparatus for retrieving images are disclosed.

### BACKGROUND

This disclosure is related to image processing and, more particularly, to retrieving images, such as selecting particular images from a database of images.

The area of content-based image retrieval includes a hybrid research area encompassing the domains of computer vision and database systems. Image databases, some quite large, are being developed and made available through Intranets and the Internet to users. Different communities of users utilize them for all sorts of applications like advertising, marketing, security, medical diagnosis, education, travel, entertainment, etc. While robust and valuable techniques for searching and finding a text item are known, more development is desired for such techniques when searching for or finding an image or one or more objects constituting an image among many images or image objects.

For example, text annotation methods for finding images may depend on the perception of the annotator and attempts to reflect the content of an image through a selection of a limited number of keywords is typically inadequate. This has resulted in an investigation of potential techniques where the image contents are determined in terms of image features, and extracted features are used to search the database for similar images. In this context, this approach is referred to as Content-Based Image Retrieval (CBIR). However, the performance of CBIR systems, developed either commercially or for research, has not been up to the mark, which has restricted their use in real world applications.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference of the following detailed description when read with the accompanying drawings in which:

FIG. 1 is a diagram illustrating an embodiment in which scanning of a binary image is employed.

FIG. 2 includes an example of an initial image and resulting other images at various points in an embodiment of segmentation processing.

FIG. 3 includes additional examples of an initial image and resulting other images at various points in an embodiment of segmentation processing.

FIG. 4 is a schematic diagram illustrating an embodiment of a size normalization process for an object.

FIG. 5 is a diagram illustrating an embodiment of a technique for computing a particular example of a substantially or relatively scale invariant shape feature.

FIG. 6 includes examples of query or initial images and the images retrieved from employing an embodiment of a method for retrieving images.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail in order so as not to obscure the claimed subject matter.

One aspect of an embodiment of the claimed subject matter includes focusing on finding regions of an image corresponding to objects that users may wish to retrieve. This or these particular embodiments are based, at least in part, on shape features that may be extracted out of segmented regions of an image.

These particular embodiments include a methodology for automated image segmentation and its use in content-based image retrieval or CBIR. In such embodiments, the segmented object is used to compute a set of shape features. The set of shape features may then be stored in the database along with the images. One such embodiment, then, may include a retrieval strategy in which shapewise similar images from the database are retrieved using an initial or query image. Of course, the claimed subject matter is not limited in scope to the particular segmentation technique described hereinafter. Many other potential segmentation techniques may be employed and remain within the scope of the claimed subject matter. Likewise, the particular technique may not produce optimal segmentation for all the cases; however, such techniques may nonetheless be suitable for CBIR. For example, advantages may be present, such as being automatic, fast and capable of performing satisfactorily with a wide range of images, including, for example, noisy and poor quality images with low contrast and brightness. Again, although the claimed subject matter is not limited to this particular technique, it, nonetheless, has been demonstrated to produce desirable results in the context of a CBIR system containing numerous poor quality images of different types of objects. Furthermore, this particular segmentation scheme, which has been demonstrated to be effective for all sorts of images, also has a low computational cost.

In this particular embodiment or methodology, the object is separated from the image through segmentation. Then different shape features of the object are identified and a feature vector is created. The images are kept in the database along with the feature vectors. From the query image, segmentation and feature extraction methods are applied and result in retrieving similar images from the database by comparing the feature vectors. Note that this segmentation embodiment is both automated and operates with the implicit assumption that the image contains a dominating object and other objects, if present, are small in comparison to the object of interest. However, again, the claimed subject matter is not limited in scope to this particular embodiment.

One aspect of this particular embodiment of the claimed subject matter is that shape features (e.g., aspect ratio, symmetry, circularity, directional area gradient etc.) tend to be almost similar for an object and its convex hull. Of course, some shape feature values like circularity, directional area gradient, etc., may tend to differ, whereas some shape feature values, such as aspect ratio, symmetry, etc., may tend to remain relatively constant or similar. In general, dissimilarity in feature value increases with the concavity in the object. However, these relative changes in shape feature values, in general, do not significantly affect the retrieval results, as will be shown through experimental results.

In this particular context, an object A is said to be convex if its intersection with a line L having any slope angle θ produces at most one line segment. Likewise, in this context, the convex hull of A is the smallest convex polygon that contains A. So, in another notation, an object A is said to be convex if its convex hull, denoted by hull(A), is substantially the same as A, e.g., hull(A)=A. Note that a circle is also considered a polygon in this context.

If θ is restricted to attain values 0° and 90°, ortho-convexity may be defined. In this context, that means, an object A is said to be ortho-convex if its intersection with a line L having slope angle θ (=0° or 90°) produces at most one line segment. If θ is allowed to attain two more values 45° and 135° only, this defines ramp-convexity. That means, in this context, an object A is said to be ramp-convex if its intersection with a line L having slope angle θ (=0° or 45° or 135°) produces at most one line segment. Suppose ortho-convex hull and ramp-convex hull of A is denoted by hull₀(A) and hullᵣ(A) respectively, then it may be shown that

hull₀(A)⊂hullᵣ(A)⊂hull(A)

Hence, in this context, the set of objects that are ramp-convex and/or ortho-convex include many objects which traditionally in mathematics are considered to be concave objects. However, generally a ramp-convex hull and an ortho-convex hull may faithfully approximate object area and, in general, produce accurate feature values. It should be noted that producing a convex hull (or a ramp-convex hull or an ortho-convex hull) may be a time consuming process. However, one embodiment of a relatively fast technique for computing such hulls is described below, although the claimed subject matter is not limited in scope to employing this technique. Other techniques may also prove satisfactory and are, therefore, included within the scope of the claimed subject matter.

A technique for generating an ortho-convex hull of object A is provided as follows. Suppose A is represented as a point set in a binary image B(i,j) as follows

$$B ( i , j ) = \{ \begin{matrix}1 & ( i , j ) ∈ A \\ 0 & otherwise\end{matrix}$$

Two other arrays, denoted H(i,j) and V(i,j), of same size as that of B(i,j), are initialized to zeros for each value or element of the arrays. Now for the rows of H(i,j), (1) start from the first column, (2) change its value to one, and (3) move horizontally until (a) B(i,j)=1 or (b) the last column is reached. If last column is not reached, (4) start from last column, (5) change its value to one, and (6) move horizontally until B(i,j)=1.

Repeat (1) to (6) for V(i,j) with the difference that the vertical direction is followed. Finally, pixel-wise, apply a logical ‘AND’ operation between the corresponding elements of H(i,j) and V(i,j), followed by a logical ‘NOT’ operation applied to the resulting values. This produces a binary image P(i,j) where a point set with binary values one represents an ortho-convex hull of A.

Likewise, a ramp-convex hull may be generated in a similar way using two more arrays, denoted D₁(i,j) and D₂(i,j,) for two diagonal directions. However, instead of applying a logical ‘AND’ operation, add corresponding pixel values of H(i,j), V(i,j) etc., and compare the array elements with a constant, such as 2 for an ortho-convex hull and 4 for a ramp-convex hull, as detailed below. Again, of course, the claimed subject matter is not limited in scope to employing this particular technique.

Likewise, it should be noted that with four arrays, H(i,j), V(i,j), D₁(i,j) and D₂(i,j), then, for this particular embodiment,

1. a constant value 4 indicates a ramp-convex hull,

2. a constant value 3 indicatesan ortho-convex hull (with respect to any two orthogonal directions, e.g., 0° and 90° or 45° and 135°), and

3. a constant value 2 indicates a wedge-convex hull, which may include more concave objects.

In this context, these objects, in general, may be referred to as ‘x-convex objects.’ An assumption is that a dominant object of an image is primarily an x-convex type, which may typically be the case for objects of interest.

For this particular embodiment, segmentation may be performed as elaborated below, although, again, the claimed subject matter is not limited in scope to applying this particular segmentation technique. Many other segmentation techniques may be employed within the scope of the claimed subject matter. However, an overview of this particular embodiment is:

| | |
|---|---|
| I. | Initial Segmentation |
| | (a) Formation of Gradient Image |
| | (b) Thresholding |
| II. | Further Segmentation |
| | (a) Formation of Gradient Image |
| | (b) Removal of Small Objects |
| | (c) Fine Tuning of Contour |

More detailed explanations of the subportions of this technique are provided below.

Here, prior to processing for segmentation, it may be desirable to remove or reduce spikes without significantly degrading edge sharpness. Any one of a number of noise reduction or removal techniques may be employed within the scope of the claimed subject matter. One such technique includes employing a median filter over a 5×5 neighborhood. In this context, this may be referred to as ‘noise reduction’ or ‘noise removal’. Of course, some embodiments may not employ noise reduction or noise removal.

In this particular embodiment, edges, such as the edges of an object of interest, may be detected at least in part on the basis of gray level discontinuities. One technique to accomplish this includes computation of a gradient (e.g., the maximum rate of change of the gray level within a specified neighborhood) at various points of the filtered image. Of course, various ways exist to locate such discontinuities or to compute a gradient. The claimed subject matter is not limited in scope to a particular technique. Nonetheless, an example neighborhood around a pixel (i,j) within which the gradient is computed and the weights given to the neighboring pixels is shown below. However, again, this is merely one example. The claimed subject matter is not limited in scope to this particular example approach or technique.

| | | | | | |
|---|---|---|---|---|---|
| a | b | c | 1 | √2 | 1 |
| d | (i, j) | e | √2 | (i, j) | √2 |
| f | g | h | 1 | √2 | 1 |

In this particular example embodiment, the gradient at center point (i, j) of a 3×3 mask, for example, is computed using the difference operator following the concept of a Weber ratio.

m₀=(c+√2e+h)/(2+√2)

m₁=(a+√2d+f)/(2+√2)

g₀=((m0−m1)/(m0+m1+1))×127

m₀=(a+√2b+c)/(2+√2)

m₁=(f+√2g+h)/(2+√2)

g₁=((m0−m1)/(m0+m1+1))×127

m₀=(√2b+c+√2e)/(1+2√2)

m₁=(√2d+f+√2g)/(1+2√2)

g₂=((m0−m1)/(m0+m1+1))×127

m₀=(√2d+a+√2b)/(1+2√2)

m₁=(√2g+h+√2l)/(1+2√2)

g₃=((m0−m1)/(m0+m1+1))×127

The intensity gradient g(i,j) at the point (i,j) is then defined as

g(i,j)=gₙ where |gₙ|≧|gₘ| for all m.

Here, the value of g(i,j) ranges from −127 to 127 and should be symmetrically distributed with zero mean. Therefore, assuming the distribution of g(i,j) follows the Laplace density function, the distribution is given by:

f(x)=(½σ)e^{-|x-μ|/σ} for −∞<x<∞

where μ is the mean and σ is the standard deviation of the population. Under this assumption, p% of the population lies in the range [μ−kσ, μ+kσ] where:

k=−ln(1−(p/100))

The term ‘gradient image’ refers to an image derived from the original or initial image that measures or reflects discontinuities in the gray values of the original or initial image. As previously indicated, the gradient image is not restricted in scope to applying the previously described computation technique.

The produced gradient image is then subject to a threshold operation to produce a binary image containing edge pixels. Although the claimed subject matter is not limited in scope in this respect, assume, for example, that less than q% of the image pixels are edge pixels and p=100−q. The threshold is μ+kσ, and μ and σ may be computed from the gradient image.

The binary or thresholded image is given by

$$B ( i , j ) = \{ \begin{matrix}1 & : if \vert g ( i , j ) \vert > μ + k σ \\ 0 & \end{matrix}$$

For the purpose of experimentation, let q=20. Of course, a fixed threshold may not give best or nearly best results for a variety of images. The claimed subject matter, of course, is not limited in scope to a particular image or set of images, or to employing a fixed threshold over an entire image. Nonetheless for this embodiment, the resulting edge images may have thick or broken or extraneous edges or their combination. However, these edge pixels are sufficient to generate an approximate x-convex hull of the object of interest, as will be seen below. This approximate x-convex hull is good enough for computing shape features. Thus, this contour of the x-convex hull may be employed as the contour of the object, resulting in segmentation as desired.

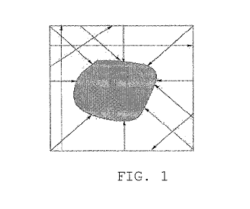

For this particular embodiment, although the claimed subject matter is not limited in scope to this particular embodiment, to find the contour of an object, the binary image is scanned starting from the image frame in four different directions. In this context scanning refers to a process of systematically locating the contour pixels of the image to perform segmentation. The approach employed for this particular embodiment is illustrated, for example, by FIG. 1. Of course, this is simply one example approach and alternate approaches are included within the scope of the claimed subject matter. However, in this particular embodiment, it is desirable to have the capability to “reach” a given point in the object contour from more than one direction from the image frame. The scanning directions used are horizontal, vertical and diagonals, e.g., from top left towards bottom right and from top right towards bottom left. For all such directions, a back and forth scanning is applied. For example, in horizontal scanning, start from a leftmost pixel in the image frame and scan towards right until an object pixel is encountered. In doing so, background pixels that are also encountered in the process become foreground pixels. In this process, this particular scan is terminated at the first object pixel encountered or, if none are encountered, at the opposite end of the binary image. Once an object pixel is encountered, a scan is started from the rightmost point of the same line in the image frame and moved left in search of another object pixel. This technique is applied for three other directions as well, in this particular embodiment, as illustrated in FIG. 1. This approach produces four images, here designated H, V, D₁ and D₂ as the result of scanning in four directions. These four images are combined to get another binary image P where:

$$P ( i , j ) = \{ \begin{matrix}1 : ( H ( i , j ) + V ( i , j ) + {D}_{1} ( i , j ) + {D}_{2} ( i , j ) ) \geq 2 \\ 0 : Otherwise\end{matrix}$$

Note that in the new binary image, the object pixels may be reached from at least two different directions. However, this process may generate small objects due to the presence of extraneous edge pixels. They may be removed, if desired, as described below.

After extraction of a background, an object contour of a predominant object is produced. Small objects may arise out of scattered extraneous edge pixels in the background. Well-known techniques, such as component labeling, may be applied and these may subsequently be removed, keeping the predominant one, as previously described.

After removal of small objects, a contour of the object of interest is generated. Scanning the resultant image similar to the way employed before may accomplish this. However, now imposing the constant value to be 3 generates an ortho- and/or ramp-convex hull of the object, based at least in part on the following:

$$P ( i , j ) = \{ \begin{matrix}1 : ( H ( i , j ) + V ( i , j ) + {D}_{1} ( i , j ) + {D}_{2} ( i , j ) ) \geq 3 \\ 0 : Otherwise\end{matrix}$$

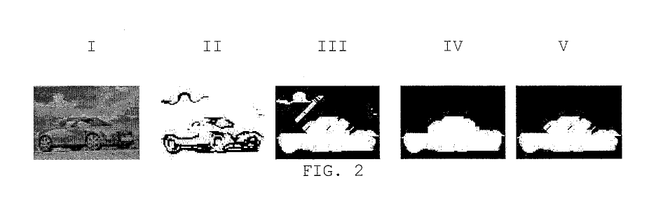

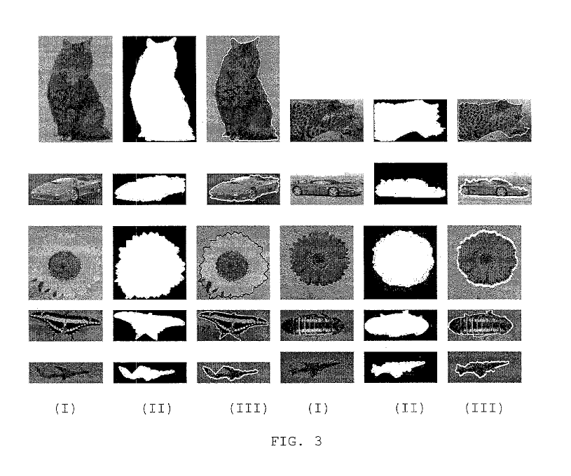

Such an approach incorporates the possibility of reaching the contour points from three or more directions; this, therefore, gives a better approximation of the contour, although, again, the claimed subject matter is not limited in scope in this respect. The segmentation process for this particular embodiment is shown in FIG. 2. In FIG. 2, for this embodiment, I denotes the original or initial image; II denotes the image after applying a threshold operation; III denotes the image after initial segmentation; IV denotes the image after removal of small components, and V denotes the image after further segmentation processing. Likewise, experimental results for a large variety of images are shown in FIG. 3, for this particular embodiment. In FIG. 3, an original or initial image is denoted I; a segmented image is denoted II; and a contour superimposed original image is denoted III.

Hereinafter, an application of this technique to segment the images for extraction of shape features, and its subsequent use to retrieve images similar to the query or initial image from a database, is described. Again, this is merely one embodiment of the claimed subject matter, and the claimed subject matter is not limited in scope to this particular embodiment or application.

As previously described, it is desirable to identify features of an object of interest; furthermore, it is desirable for these features to be relatively stable or invariant to scaling, rotation and/or translation.

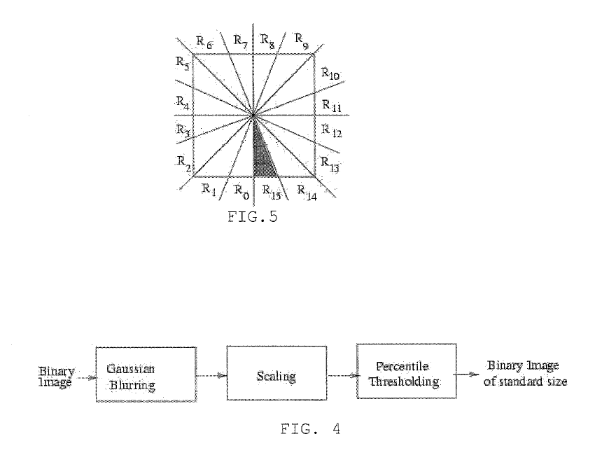

The image objects are converted into a fixed size to make extracted features substantially or relatively scale invariant. For image objects of different size, the features may be made substantially or relatively scale invariant. Likewise, extraction of some intermediate features may make size normalization particularly desirable. Hence, for this particular embodiment, a bounding rectangle of an object is converted to have size 256×256 while preserving the aspect ratio of the original or initial image. Of course, the claimed subject matter is not limited in scope to this particular size, or to employing size normalization. However, for this embodiment, the process of normalization is shown in FIG. 4.

In this context, shape may be roughly defined as the description of an object irrespective of its position, orientation and/or size. As the shape information is mostly contained in the boundary/edges, the features that have been computed from the contour of an object may be referred to as shape features. Examples of shape features include moment, directional area gradient, circularity and aspect ratio, although, of course the claimed subject matter is not limited in scope to only these particular shape features.

Moments and functions of moments are widely used for shape detection. Hu has derived a set of moments using nonlinear combinations of geometric moments that are nearly or relatively invariant under image translation, rotation and/or scaling. See Hu, M. K., “Visual Pattern Recognition by Moment Invariants,” IRE Trans. Info. Theory, Vol. IT-8, 1962, pp 179-187; Rafel C. Gonzalez and Richard E. Woods, Digital Image Processing, Addison-Wesley Publication Company, USA, 1993. In our case this set is calculated considering the contour pixels and then stored as a vector. A set of seven invariant moments, such as described in Hu, may be derived from the second and third order moments, as follows, although, of course, the claimed subject matter is not limited in scope in this respect.

φ₁=η₂₀+η₀₂

φ₂=(η₂₀−η₀₂)²+4η₁₁²

φ₃=(η₃₀−3η₁₂)²+(3η₂₁−η₀₃)²

φ₄=(η₃₀+η₁₂)²+(η₂₁+η₀₃)²

φ₅=(η₃₀−3η₁₂)(η₃₀+η₁₂)[(η₃₀+η₁₂)²−3(η₂₁+η₀₃)²]+(3η₂₁−η₀₃)(η₂₁+η₀₃)[3(η₃₀+η₁₂)²−(η₂₁+η₀₃)²]

φ₆=(η₂₀−η₀₂)[(η₃₀+η₁₂)²−(η₂₁+η₀₃)²]+4η₁₁(η₃₀+η₁₂)(η₂₁+η₀₃)

φ7=(3η₂₁−η₀₃)(η₃₀+η₁₂)[(η₃₀+η₁₂)²−3(η₂₁+3η₀₃)²]+(3η₁₂−η₃₀)(η₂₁+η₀₃)[3(η₃₀+η₁₂)²−(η₂₁+η₀₃)²]

where ηᵢⱼ are normalized central moments.

Another shape feature in this context may be referred to as a directional area gradient. The image object may be divided into 16 regions and the percentage area, e.g., regional area/total object area, for each region may be computed, as illustrated in FIG. 5. This may provide an estimate for the relative distribution of the pixels in different directional areas. The gradient of the percentage area may be taken as a shape feature. Likewise, this gradient, for this particular embodiment, may be computed by fitting a straight line using least square regression in a percentage area versus region graph. This tends to be substantially or relatively translation and/or scale invariant. To make it also relatively rotation invariant, regions may be cyclic-shifted resulting in a new order. So a new combination is obtained which represents the case for a rotated image. For each such rotation, the gradient may be calculated and the maximum may be taken as a feature. Again, however, the claimed subject matter is not limited in scope to this particular shape feature or to this particular method of calculation.

To produce another shape feature, although, again, the claimed subject matter is not limited to these examples or to this embodiment, the distance between two farthest points in the contour may be computed and considered as the diameter (D) of a circle enclosing the image object. In this context, circularity may then be defined by

circularity=4×Object area/(π×D²)

It may be noted that this is substantially or relatively scale, rotation and/or translation invariant.

For yet another example of a shape feature, let w and h be the width and height of the minimum bounding box of the segmented object, respectively. The aspect ratio is defined as w/h or h/w, but this is not rotation invariant. For any rotation θ, the modified width (w′) and height (h′) may be computed as follows:

w′=(w cos θ−h sin θ) and h=(h cos θ+w sin θ)

Now, by varying θ from 0° to 180° in increments of 5°, for example, an aspect ratio may be determined by taking the maximum value obtained. Again, the claimed subject matter is not limited in scope to this shape feature or to this particular method of calculation.

In this embodiment, feature vector having a length corresponding to a set of shape features may be stored for images in a database. In one embodiment of a CBIR system in accordance with the claimed subject matter, usage is then made of different shape features. Experimental results are obtained regarding the effectiveness of shape features and efficacy of employing segmentation. It may be noted that while embodiments of the claimed subject matter with regard to the segmentation and extraction of shape features, for example, and their applicability in an image retrieval paradigm has been described, these techniques may also be applied to multi-dimensional indexing and remain within the scope of the claimed subject matter.

For experimental purposes, an image database, including about 511 color/gray images of varying sizes, has been employed. The database images are collections of thumbnails comprising five different classes, namely cars, insects, flowers, airplanes and animals. The database was searched for retrieval of a similar image using a query image by applying the previously described embodiment. For the purposes of producing these results, initial or query images were taken from the database itself. However, the search process for this particular embodiment, in general, is as follows.

1. Get the query image.

2. Segment it for dominant object (e.g., object of interest).

3. Extract feature vector.

4. Measure similarity by comparing feature vectors of the query image and that of the database images using a “distance” measure, such as a Euclidean distance measure.

Here, DA_{diff} denotes the difference of the directional area gradient feature of the query image and that of an image in the database. Similarly, MI_{diff}, CI_{diff} and AR_{diff} denote the difference of the moment feature, circularity feature and aspect ratio feature, respectively. Here, W_{DA}, W_{MI}, W_{CI}, and W_{AR} are the weights given to these features respectively. Then, for this particular embodiment, the overall difference between the features of the query image and that of an image in the database is

DIFF=W_{DA}*DA_{diff}+W_{MI}*MI_{diff}+W_{CI}*CI_{diff}+W_{AR}*AR_{diff}

The smaller the difference between the query image and the database image being compared, the more similar the image objects are. Contributions of different types of features to describe the objects are assumed to be substantially same in this embodiment. That means, in this embodiment, the values of the weights are substantially the same, although, of course, the claimed subject matter is not limited in scope in this respect. For example, depending on the particular situation, an appropriate proportioning of contributions by these various features may be determined to devise a more effective similarity measure.

By way of example, and not intended to limit the scope of the claimed subject matter in any way, a COMPAQ DS20E Server with one Alpha 21264 CPU was employed running at 500 MHz. This resulted in an average search time from the 511 image database of about 0.0215 seconds, without using indexing and/or an optimized retrieval strategy. It may also be noted that no optimization of code was used.

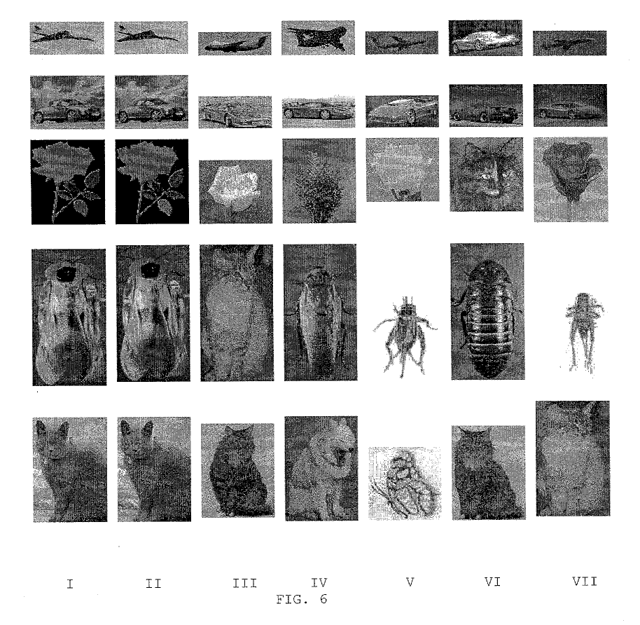

Results are shown in FIG. 6 where the query results with examples from each class of image are illustrated; namely, in this example, airplanes, cars, animals, flowers and insects. For the query images, the nearest six are shown in order of ‘distance.’ It may be noted that for the query images, the initial image used was retrieved and appears in the first position with a distance of zero, as desired.

It may be noted that, although the claimed subject matter is not limited in scope to the particular embodiments described, an embodiment of an automated segmentation scheme has been provided, including the following aspects: a threshold value is determined based, at least in part, on characteristics of the images using a computationally efficient strategy; an automated segmentation technique is provided for shape based CBIR; suitable results are obtained for a variety of images with varying shape features; and a computationally quick scheme that produces segmentation of objects acceptable for CBIR with a low computational overhead is employed.

It will, of course, be understood that, although particular embodiments have just been described, the claimed subject matter is not limited in scope to a particular embodiment or implementation. For example, one embodiment may be in hardware, whereas another embodiment may be in software. Likewise, an embodiment may be in firmware, or any combination of hardware, software, or firmware, for example. Likewise, although the claimed subject matter is not limited in scope in this respect, one embodiment may comprise an article, such as a storage medium. Such a storage medium, such as, for example, a CD-ROM, or a disk, may have stored thereon instructions, which when executed by a system, such as a computer system or platform, or an imaging system, for example, may result in an embodiment of a method in accordance with the claimed subject matter being executed, such as an embodiment of a method of image retreival, for example, as previously described.

While certain features of the claimed subject matter have been illustrated and described herein, many modifications, substitutions, changes and equivalents will now occur to those skilled in the art. It is, therefore, to be understood that the appended claims are intended to cover all such modifications and changes as fall within the true spirit of the invention

1. A method of processing an initial image comprising:
applying noise reduction;
producing another image to detect discontinuities in gray levels; and
removing less significant discontinuities.

2. The method of claim 1, wherein applying noise reduction includes applying a median filter to the initial image to produce a filtered image.

3. The method of claim 2, wherein the median filter is applied across the image in 5 by 5 neighborhoods.

4. The method of claim 2, wherein producing another image to detect discontinuities in gray levels includes producing a gradient image from the filtered image.

5. The method of claim 4, wherein removing less significant discontinuities includes thresholding the gradient image.

6. The method of claim 5, and further comprising, identifying a contour of an object of the initial image by scanning the thresholded gradient image.

7. The method of claim 6, and further comprising, computing at least one scale invariant feature from the contour of the object identified.

8. The method of claim 7, wherein the at least one substantially scale invariant feature of the object is compared with a corresponding substantially scale invariant feature of a plurality of images.

9. The method of claim 7, wherein the at least one substantially scale invariant feature of the contour of the object includes at least one of the following: moment, directional area gradient, circularity and aspect ration.

10. The method of claim 6, and further comprising, computing more than one scale invariant feature from the contour of the object identified.

11. The method of claim 10, wherein the more than one substantially scale invariant feature of the object is compared with more than one corresponding substantially scale invariant features of a plurality of images.

12. The method of claim 11, wherein the more than one substantially scale invariant feature of the contour of the object includes at least more than one of the following: moment, directional area gradient, circularity and aspect ration.

13. An article comprising: a storage medium having stored thereon instructions that, when executed, result in the following:
applying noise reduction;
producing another image to detect discontinuities in gray levels; and
removing less significant discontinuities.

14. The article of claim 13, wherein, said instructions, when executed, result in applying noise reduction that further includes applying a median filter to the initial image to produce a filtered image.

15. The article of claim 13, wherein, said instructions, when executed, result in producing another image to detect discontinuities in gray levels that further includes producing a gradient image from the filtered image.

16. The article of claim 15, wherein, said instructions, when executed, result in removing less significant discontinuities that further includes thresholding the gradient image.

17. The article of claim 16, wherein, said instructions, when executed, result in further identifying a contour of an object of the initial image by scanning the thresholded gradient image.

18. The article of claim 17, wherein, said instructions, when executed, result in computing at least one scale invariant feature from the contour of the object identified.

19. A system comprising:
a computing platform, said computing platform having the capability to process an initial image by:
detecting discontinuities in gray levels; and
removing less significant discontinuities.

20. The system of claim 19, wherein the computing platform comprises a computer.

21. The system of claim 19, wherein said computing platform further includes the capability to reduce noise in the initial image.

22. The system of claim 21, wherein said computing platform has the capability to detect discontinuities in gray levels in the initial image by producing a gradient image.

23. The system of claim 22, wherein said computing platform has the capability to remove less significant discontinuities by thresholding.
